(19) United States
(12) Patent Application Publication
(10) Pub. No.: US 2009/0133809 A1
(43) Pub. Date: May 28, 2009

(54) METHOD AND TYRE BUILDING DRUM FOR BUILDING A TYRE

(75) Inventors: Henk-Jan Grolleman, VC Eerbeek (NL); Luuk Van Tienen, AJ Terwolde (NL); Jakob Pieter De Vries, DX Zwolle (NL)

Correspondence Address: LADAS & PARRY LLP, 26 WEST 61ST STREET, NEW YORK, NY, 10023, US

(73) Assignee: VMI HOLLAND B.V..

(21) Appl. No.: 12/275,260

(22) Filed: Nov. 21, 2008

Related U.S. Application Data
(60) Provisional application No. 61/004,291, filed on Nov. 26, 2007.

(51) Int. Cl. B29D 30/20; B29D 30/24

(52) U.S. Cl. 156/135; 156/414

(57) ABSTRACT

When building an unvulcanised tyre from tyre components using a tyre building drum, the mutual distances considered in axial direction between a bead ring segment, a first end and a steering element of a folding arm in question are chosen such that at movement of a steering element towards the bead ring segment a steering surface comes to abut the steering element so that the roller element can be moved from a first position, after which the roller element presses an outer part of the tyre components against a bead ring core to be placed on the bead ring segment while simultaneously the roller element moves away from the longitudinal axis, wherein the steering element moves along the steering surface until the stop of the annular steering segment abuts an annular folding arm segment, after which the folding arm swivels about a swivel axle and the steering element comes to lie apart from the steering surface.

### BACKGROUND OF THE INVENTION

The invention relates to a method for building an unvulcanised tyre using tyre components of rubber, in which method a tyre building drum is used having a longitudinal axis and provided with two bead ring segments placed around the longitudinal axis and spaced apart from each other, wherein each bead ring segment is intended for supporting a bead ring core, with means for radially expanding a part of the tyre components placed between the ring segments, wherein the tyre building drum comprises a set of axially extending folding arms on each side outside of the bead ring segments, wherein each folding arm is provided with a first end oriented to the bead ring segment in question and provided with a roller element for directly contacting a tyre component, and wherein each folding arm at a second end facing away from the bead ring segment in question is connected via a swivel axle to a longitudinally slidable annular folding arm segment placed around the longitudinal axis, wherein the tyre building drum is furthermore provided with means for axially and radially moving each set of arms from a first position, in which the roller elements of the set of arms form an at least substantially closed ring, to a second position, for pressing a part of the tyre components placed outside of the bead ring segments against the expanded part of the tyre components placed within the bead ring segments.

Such a method is known from EP-B1-1.272.338. In the method described therein the roller elements of the sets of arms form an at least substantially closed ring, which when the folding arms move towards the bead ring segments fold the part of the tyre components situated outside of the bead ring segments, below also called the outer tyre components, over the bead ring core and press it against the bead ring core and against the part of the tyre components situated within the bead ring segments, below also called the inner tyre components. Although the known method functions adequately in general, the roller elements form undesirable imprints in the tyre when certain types of tyre components are used. Said imprints arise because the roller elements that are in direct contact with the tyre components exert too high a force on the tyre components. Particularly in case of tyres having a thickening in the outer tyre components, such as among others off-the-road tyres, there is a risk of said undesirable imprints arising.

### SUMMARY OF THE INVENTION

It is an object of the present invention to provide a method for building a tyre, wherein despite the use of roller elements that contact the tyre components directly it is prevented that imprints arise in the tyre components.

According to the invention this object is achieved because the method comprises the step of designing the tyre building drum such that the means for axially and radially moving each set of folding arms comprise a longitudinally slidable annular steering segment which is provided with a sloping steering surface which in axial direction of a bead ring segment in question slopes to the outside in the direction away from the longitudinal axis, wherein each folding arm is provided with a steering element situated between both ends of the folding arm which steering element can be made to abut the steering surface, and wherein the annular steering segment is provided with a stop for an annular folding arm segment, wherein the annular folding arm segment is situated between the annular steering segment in question and the bead ring segment in question, wherein in the first position of the folding arms the stop of the annular steering segment is situated spaced apart from the annular folding arm segment, and in that the method comprises the step of choosing the mutual distances such considered in axial direction between a bead ring segment, the first end and the steering element of a folding arm in question, that from the situation in which the folding arms are in the first position when moving the steering segment towards the bead ring segment, the steering surface will come to abut the steering element so that the roller element is moveable from the first position, after which at further movement of the steering segment towards the bead ring segment the roller element at the first end of the folding arm presses the part of the tyre components outside of the bead ring segments against a bead ring core to be placed on the bead ring segment while simultaneously the roller element moves away from the longitudinal axis, wherein the steering element moves along the steering surface until the stop of the annular steering segment comes to abut the annular folding arm segment, after which the folding arm swivels about the swivel axle and the steering element comes to lie apart from the steering surface. Due to the use of the steering element, that may be designed as a cam, a roller or another form of a cam follower that is known per se, the steering element provides as it were an extra rotation point for the folding arm. Said extra rotation point when engaged by the sloping steering surface becomes an extra point of application of forces, as a result of which, depending on the size of the slope of the steering surface, the axial force exerted by the roller element on the outer tyre components, also called side wall, is considerably reduced as a result of which the risk of imprints is strongly reduced and may even be completely absent. An additional advantage of said extra point of rotation, i.e. the steering element, is that it ensures that during the first part of folding the swivel axle is able to move freely, as a result of which the roller element is free to follow the contour of the outer tyre components, which is advantageous in case of outer tyre components provided with a thickening.

Please note that the use of an extra steering element and a steering surface is known per se from US-A-3.887.423. In the method described in said document, however, a tyre building drum is used having a so-called annular bladder which is arranged on the outer sides around the folding arms. The size of the slope and the mutual distance between the relevant elements, however, should be chosen such that the folding arm in the first part of folding tensions the bladder so that the bladder presses the outer tyre components against the bead ring core. In the first part of folding the roller elements therefore do not press the outer tyre components directly against the inner tyre components. By using such a bladder the creation of imprints is prevented. Not until the bead ring core has been passed during the folding arms moving to the inside, do the roller elements press the bladder against the central part of the inner tyre components. Indeed because it is the bladder and not the roller elements themselves, that press the outer tyre components against the bead ring core, the method described in US-A-3.887.423 may in some case not be optimal for folding and pressing the outer tyre components against the bead ring core. The techniques described in EP-B1-1.272.338 and US-A-3.887.423 therefore are totally different.

In an advantageous embodiment of a method according to the invention the method further comprises the step of designing the tyre building drum such that the roller element and the steering element of a folding arm in the first position of the folding arm are situated at least substantially at the same radial distance from the longitudinal axis. In this way a better and reproducible distribution of the forces exerted on the outer tyre components by the roller element can be realised. An even better distribution can be achieved when the method further comprises the step of designing the tyre building drum such that in the first position of the folding arm the swivel axle of the folding arm is situated at a shorter radial distance from the longitudinal axis than the roller element and the steering element are.

In a further advantageous embodiment of a method according to the invention the method comprises the step of choosing the size of the slope of the steering surface such that when moving the steering segment towards the bead ring segment a desired axial pressure on the tyre components is realised. The steeper the slope of the steering surface, the larger the axial component of the force exerted on the outer tyre components by the roller element. By choosing the size of the slope of the steering surface it is therefore possible to realise a specific pressure force for specific tyre components. It is also possible to use a steering surface having a varying slope angle size to realise a certain development of the pressure force.

The invention furthermore relates to a tyre building drum having a longitudinal axis and provided with two bead ring segments placed around the longitudinal axis and spaced apart from each other, wherein each bead ring segment is intended for supporting a bead ring core, with means for radially expanding a part of the tyre components placed between the ring segments, wherein the tyre building drum comprises a set of axially extending folding arms on each side outside of the bead ring segments, wherein each folding arm is provided with a first end oriented to the bead ring segment in question and provided with a roller element, and wherein each folding arm at a second end facing away from the bead ring segment in question is connected via a swivel axle to a longitudinally slidable annular folding arm segment placed around the longitudinal axis, wherein the tyre building drum is furthermore provided with means for axially and radially moving each set of arms from a first position, in which the roller elements of the set of arms form an at least substantially closed ring, to a second position, for pressing a part of the tyre components placed outside of the bead ring segments against the expanded part of the tyre components placed within the bead ring segments, wherein the means for axially and radially moving each set of arms comprise a longitudinally slidable annular steering segment provided with a sloping steering surface which in axial direction of a bead ring segment in question slopes to the outside in the direction away from the longitudinal axis, wherein each folding arm is provided with a steering element situated between both ends of the folding arm which steering element can be made to abut the steering surface, and wherein the annular steering segment is provided with a stop for an annular folding arm segment, wherein the annular folding arm segment is situated between the annular steering segment in question and the bead ring segment in question, wherein in the first position of the folding arms the stop of the annular steering segment is situated spaced apart from the annular folding arm segment, wherein the mutual distances considered in axial direction between a bead ring segment, the first end and the steering element of a folding arm in question have such a size that the method according to the invention can be carried out.

In an advantageous embodiment of a tyre building drum according to the invention the roller element and the steering element of a folding arm in the first position of the folding arm are situated at least substantially at the same radial distance from the longitudinal axis. In that case it is furthermore advantageous when in the first position of the folding arm the swivel axle of the folding arm is situated at a shorter radial distance from the longitudinal axis than the roller element and the steering element are.

### SHORT DESCRIPTION OF THE DRAWINGS

The invention will be elucidated on the basis of a number of exemplary embodiments shown in the attached drawings, in which:

FIG. 1 shows a schematic cross-section of a part of a tyre building drum for building an unvulcanised tyre wherein the folding arms are in the first, the inactive, position, and

FIG. 2 shows a schematic cross-section of a part of a tyre building drum for building an unvulcanised tyre wherein the folding arms are in a position in which the outer tyre components are pressed against the bead ring core.

### DETAILED DESCRIPTION OF THE DRAWINGS

The invention among others relates to a method for building an unvulcanised tyre using tyre components of rubber, such as for instance known from EP-B1-1.272.338.

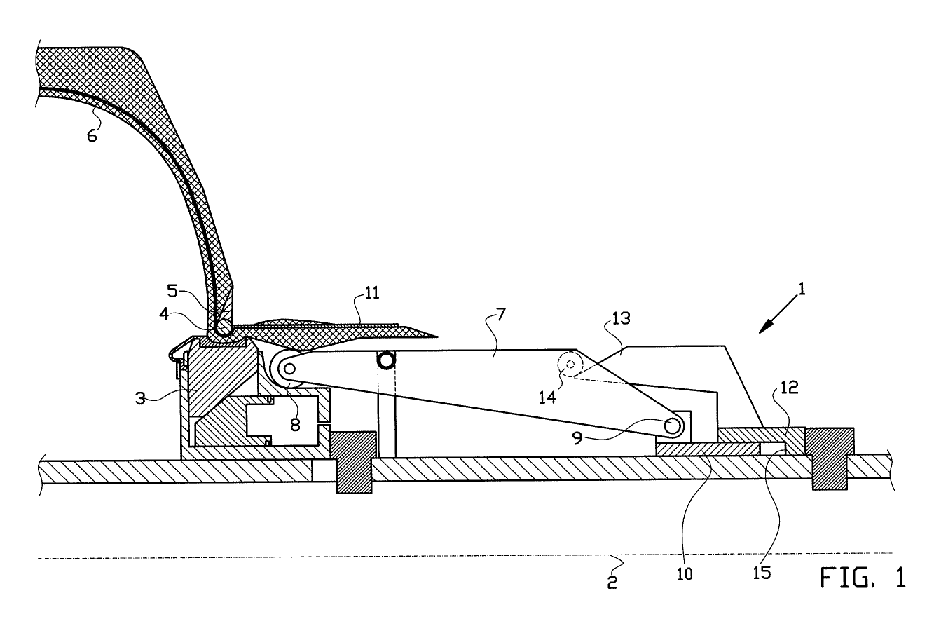

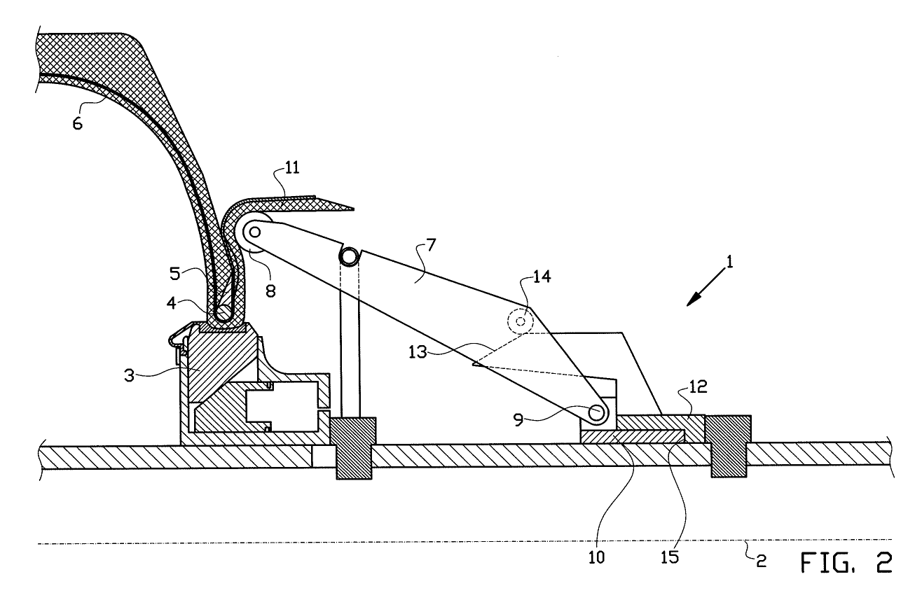

In the method a tyre building drum 1 is used of which in FIGS. 1 and 2 only the upper right part is shown. The other parts, as known, are designed symmetrical with respect to said part.

The tyre building drum 1 has a longitudinal axis 2 and is provided with two bead ring segments 3 (of which one is shown in the figures), which are placed around the longitudinal axis 2 and are spaced apart from each other. Each bead ring segment 3 is intended for supporting a bead ring core 4 optionally provided with a filling strip 5.

The tyre building drum 1 further comprises means that are known per se and not shown in the figures, for radially expanding a part of the tyre components 6 placed between the bead ring segments 3.

On each side outside of the bead ring segments 3 the tyre building drum 1 comprises a set of axially extending folding arms 7 (of which one is shown in the figures). Each folding arm 7 is provided with a first end oriented towards the bead ring segment 3 in question and provided with a roller element 8 able to directly contact a tyre component. Each folding arm 7 furthermore at a second end facing away from the bead ring segment 3 in question has a swivel axle 9 with which said folding arm 7 is connected to a longitudinally slidable annular folding arm segment 10 placed around the longitudinal axis 2.

The tyre building drum 1 is furthermore provided with means for axially and radially moving each set of arms 7 from a first (inactive) position (shown in FIG. 1) in which the roller elements 8 of the set of arms 7 form an at least substantially closed ring, to a second position (shown in FIG. 2) for pressing a part 11 of the tyre components placed outside of the bead ring segments 3 against the expanded part 6 of the tyre components placed within the bead ring segments 3. In the embodiment shown the outer part 11 of the tyre components contains a thickening, such as for instance used in tyres intended for off-the-road use. The movement of the arms towards the bead ring segments may for instance, and as known per se, be realised by for instance pneumatic drives or comparable drives.

The tyre building drum 1 is and has furthermore been designed such that the means for axially and radially moving each set of folding arms 7 comprises a longitudinally slidable annular steering segment 12 that is provided with sloping steering surface 13 which in axial direction of a bead ring segment 3 in question slopes to the outside in the direction away from the longitudinal axis 2. Moreover each folding arm 7 is provided with a steering element 14 situated between both ends of the folding arm 7, which steering element can be made to abut the steering surface 13. Due to the use of the steering element 14, that may be designed as a cam, a roller or another form of a cam follower that is known per se, the steering element 14 provides as it were an extra rotation point for the folding arm 7. Said extra rotation point when engaged by the sloping steering surface 14 becomes an extra point of application of forces, as a result of which, depending on the size of the slope of the steering surface 14, the axial force exerted by the roller element 8 on the outer tyre components 11, also called side wall, is considerably reduced as a result of which the risk of undesired imprints on the tyre components is strongly reduced and may even be completely absent. An additional advantage of said extra point of rotation, i.e. the steering element 14, is that it ensures that during the first part of folding the swivel axle 9 is able to move freely, as a result of which the roller element 8 is free to follow the contour of the outer tyre components 11, which is advantageous in case of outer tyre components provided with a thickening.

The annular steering segment 12 is furthermore provided with a stop 15 (a stop surface in the embodiment shown) for an annular folding arm segment 10. The annular folding arm segment 10 is in this case situated between the annular steering segment 12 in question (its stop surface 15) and the bead ring segment 3 in question.

In the first position of the folding arms 7 (as shown in FIG. 1) the stop 15 of the annular steering segment 12 is spaced apart from the annular folding arm segment 10. The mutual distances considered in axial direction between a bead ring segment 3, the first end (8) and the steering element 14 of a folding arm 7 in question are chosen such that from the situation in which the folding arms 7 are in the first position (as shown in FIG. 1) at movement of the steering segment 12 towards the bead ring segment 3, the steering surface 13 will come to abut the steering element 14 so that the roller element 8 is moved from the first position. At further movement of the steering segment 12 towards the bead ring segment 3 the roller element 8 at the first end of the folding arm 7 presses the part 11 of the tyre components outside of the bead ring segments 3 against a bead ring core 4, 5 placed on the bead ring segment 3, while simultaneously moving the roller element 8 away from the longitudinal axis 2. Here the steering element 14 moves along the steering surface 13 until the abutment 15 of the annular steering segment 12 comes to abut the annular folding arm segment 10, after which the folding arm 7 swivels about the swivel axle 9 and the steering element 14 comes to lie apart from the steering surface 13. In FIG. 2 the situation is shown in which the steering element 14 just about contacts the steering surface 13. In this way the outer part 11 of the tyre components is pressed against the bead ring core 4, 5 by the roller element 8 from the start.

As indicated by the force arrows in FIG. 1, the size of the slope of the steering surface 13 defines the size of the axial force exerted on the tyre components by the roller element 8 when the steering segment 12 moves to the bead ring segment 3. By choosing the size of the slope of the steering surface 13, the size of said axial force can therefore be adjusted to a desired axial pressure.

In the embodiment shown the roller element 8 and the steering element 13 of a folding arm 7 in the first position (shown in FIG. 1) of the folding arm 7, are situated at least substantially the same radial distance from the longitudinal axis 2. As a result a proper, reproducible distribution of the force exerted on the tyre components by the roller element 8, is achieved. It is furthermore advantageous that in said first position of the folding arm the swivel axle 9 of the folding arm 7 is situated at a shorter radial distance from the longitudinal axis 2 than the roller element 8 and the steering element 13 are.

The above description is included to illustrate the operation of preferred embodiments of the invention and not to limit the scope of the invention. Starting from the above explanation many variations that fall within the spirit and scope of the present invention, particularly as defined in the attached claims, will be evident to an expert.

1. Method for building an unvulcanised tyre using tyre components of rubber, in which method a tyre building drum is used having a longitudinal axis and provided with two bead ring segments placed around the longitudinal axis and spaced apart from each other, wherein each bead ring segment is intended for supporting a bead ring core, with means for radially expanding a part of the tyre components placed between the ring segments, wherein the tyre building drum comprises a set of axially extending folding arms on each side outside of the bead ring segments, wherein each folding arm is provided with a first end oriented to the bead ring segment in question and provided with a roller element for directly contacting a tyre component, and wherein each folding arm at a second end facing away from the bead ring segment in question is connected via a swivel axle to a longitudinally slidable annular folding arm segment placed around the longitudinal axis, wherein the tyre building drum is furthermore provided with means for axially and radially moving each set of arms from a first position, in which the roller elements of the set of arms form an at least substantially closed ring, to a second position, for pressing a part of the tyre components placed outside of the bead ring segments against the expanded part of the tyre components placed within the bead ring segments, characterised in that the method comprises the step of designing the tyre building drum such that the means for axially and radially moving each set of folding arms comprise a longitudinally slidable annular steering segment which is provided with a sloping steering surface which in axial direction of a bead ring segment in question slopes to the outside in the direction away from the longitudinal axis, wherein each folding arm is provided with a steering element situated between both ends of the folding arm which steering element can be made to abut the steering surface, and wherein the annular steering segment is provided with a stop for an annular folding arm segment, wherein the annular folding arm segment is situated between the annular steering segment in question and the bead ring segment in question, wherein in the first position of the folding arms the stop of the annular steering segment is situated spaced apart from the annular folding arm segment, and in that the method comprises the step of choosing the mutual distances such considered in axial direction between a bead ring segment, the first end and the steering element of a folding arm in question, that from the situation in which the folding arms are in the first position when moving the steering segment towards the bead ring segment, the steering surface will come to abut the steering element so that the roller element is moveable from the first position, after which at further movement of the steering segment towards the bead ring segment the roller element at the first end of the folding arm presses the part of the tyre components outside of the bead ring segments against a bead ring core to be placed on the bead ring segment while simultaneously the roller element moves away from the longitudinal axis, wherein the steering element moves along the steering surface until the stop of the annular steering segment comes to abut the annular folding arm segment, after which the folding arm swivels about the swivel axle and the steering element comes to lie apart from the steering surface.

2. Method according to claim 1, characterised in that the method further comprises the step of designing the tyre building drum such that the roller element and the steering element of a folding arm in the first position of the folding arm are situated at least substantially at the same radial distance from the longitudinal axis.

3. Method according to claim 2, characterised in that the method further comprises the step of designing the tyre building drum such that in the first position of the folding arm the swivel axle of the folding arm is situated at a shorter radial distance from the longitudinal axis than the roller element and the steering element are.

4. Method according to claim 1, characterised in that the method comprises the step of choosing the size of the slope of the steering surface such that when moving the steering segment towards the bead ring segment a desired axial pressure on the tyre components is realised.

5. Tyre building drum having a longitudinal axis and provided with two bead ring segments placed around the longitudinal axis and spaced apart from each other, wherein each bead ring segment is intended for supporting a bead ring core, with means for radially expanding a part of the tyre components placed between the ring segments, wherein the tyre building drum comprises a set of axially extending folding arms on each side outside of the bead ring segments, wherein each folding arm is provided with a first end oriented to the bead ring segment in question and provided with a roller element, and wherein each folding arm at a second end facing away from the bead ring segment in question is connected via a swivel axle to a longitudinally slidable annular folding arm segment placed around the longitudinal axis, wherein the tyre building drum is furthermore provided with means for axially and radially moving each set of arms from a first position, in which the roller elements of the set of arms form an at least substantially closed ring, to a second position, for pressing a part of the tyre components placed outside of the bead ring segments against the expanded part of the tyre components placed within the bead ring segments, wherein the means for axially and radially moving each set of arms comprise a longitudinally slidable annular steering segment provided with a sloping steering surface which in axial direction of a bead ring segment in question slopes to the outside in the direction away from the longitudinal axis, wherein each folding arm is provided with a steering element situated between both ends of the folding arm which steering element can be made to abut the steering surface, and wherein the annular steering segment is provided with a stop for an annular folding arm segment, wherein the annular folding arm segment is situated between the annular steering segment in question and the bead ring segment in question, wherein in the first position of the folding arms the stop of the annular steering segment is situated spaced apart from the annular folding arm segment, wherein the mutual distances considered in axial direction between a bead ring segment, the first end and the steering element of a folding arm in question have such a size that the method according to claim 1 can be carried out.

6. Tyre building drum according to claim 5, characterised in that the roller element and the steering element of a folding arm in the first position of the folding arm are situated at least substantially at the same radial distance from the longitudinal axis.

7. Tyre building drum according to claim 6, characterised in that in the first position of the folding arm the swivel axle of the folding arm is situated at a shorter radial distance from the longitudinal axis than the roller element and the steering element are.
